(19) United States
(12) Patent Application Publication
(10) Pub. No.: US 2009/0198565 A1
(43) Pub. Date: Aug. 6, 2009

(54) IDEA COLLABORATION SYSTEM

(75) Inventors: Paul Pluschkell, JR., Pleasanton, CA (US); Padmanabh Dinkar Dabke, Danville, CA (US)

Correspondence Address: PEPPER HAMILTON LLP, ONE MELLON CENTER, 50TH FLOOR, 500 GRANT STREET, PITTSBURGH, PA, 15219, US

(73) Assignee: SPIGIT, INC., Pleasanton, CA (US)

(21) Appl. No.: 12/364,291

(22) Filed: Feb. 2, 2009

Related U.S. Application Data
(60) Provisional application No. 61/025,550, filed on Feb. 1, 2008.

(51) Int. Cl. G06Q 10/00; G06Q 99/00; G06Q 50/00

(52) U.S. Cl. 705/10; 705/1

(57) ABSTRACT

An idea collaboration system includes an innovation market that accepts and displays user-submitted ideas; a discussion section that allows registered users to comment on and ranking ideas; and an idea merit section that displays an indication of merit for the ideas. The indication of merit for each idea is based on at least: (i) a number of different registered users who have submitted comments for the idea; (ii) a determination of user interest for the idea; and (iii) a reputation rank for registered users who provided a positive ranking for the idea.

### CROSS REFERENCE TO RELATED APPLICATIONS

This patent application claims priority to U.S. Provisional Patent Application No. 61/025,550, filed Feb. 1, 2008. This application is related to co-pending U.S. patent application Ser. No. ______, filed Feb. 2, 2009.

### BACKGROUND

In today's economy, innovation is essential to the long-term success of an organization. In many organizations, new products, services, marketing initiatives, supporting tools, and other ideas arise on a frequent basis. However, the tools that allow organizations to share, collaborate on, improve, evaluate, filter and rank new ideas are very limited.

This disclosure describes a method and system that is directed to solving one or more of the problems described above.

### SUMMARY

In an embodiment, an idea collaboration system includes an innovation market that accepts and displays user-submitted ideas. A discussion section accepts comments and rankings about each idea from users. An idea merit section determines, using a processing device, and displays, via a display device, an indication of merit for each idea. The indication of merit for each idea is a measurement that may be based on at least a number of different registered users who have submitted comments to the discussion section for the idea; a determination of user interest for the idea, and a reputation rank for each registered user from whom the discussion section received a positive ranking for the idea. The system also may include a reward module that provides rewards to registered users based on their participation in the discussion section, their reputation level, and the merit ranking of their ideas.

Optionally, the indication of merit for an idea also may be based on a ratio of a number of outstanding shares corresponding to the idea to a total number of outstanding shares in the innovation market; and a ratio of a market capitalization corresponding to the idea to a total market capitalization for the innovation market. The idea merit section also may determine whether each idea should graduate to a next level, and the reward module may provide a reward to a submitter of an idea if the idea merit system determines that the idea should graduate to the next level. The determination of user interest in any idea may be based on at least a total number of comments that have been received into the discussion section for the idea and a number of page views that the idea has generated.

The reputation rank for each registered user may be determined based on a number of discussion posts that the discussion section has received from the registered user, along with a number of positive responses to the registered user's discussion posts that the discussion section has received from other users. The reputation rank for each registered user also may be based on a past performance of the registered user in correctly betting on prediction market instruments; and a past performance of the registered user in correctly rating and buying shares in ideas in the innovation market. The reputation rank for each registered user also may be based on a past performance of the registered user in posting ideas with successful exit. The reputation rank for each registered user also may be determined based on a number of friends that have connected to the registered user as connected friends, a number of positive rankings that the connected friends have submitted for the registered user, and a number of negative rankings that the connected friends have submitted for the registered user. In an alternate embodiment, a method of collaboration includes receiving a first idea from a first registered user into an idea collaborative system. The first idea is displayed to additional registered users. The registered users submit to the idea collaboration system comments and rankings for the first idea. A processing device determines a merit ranking for the first idea by considering at least a number of different registered users who have submitted comments for the first idea, a user interest for the first idea, and a reputation rank for registered users who have submitted a ranking for the first idea.

The merit ranking also may consider a ratio of a number of outstanding shares corresponding to the first idea to a total number of outstanding shares in the innovation market; and a ratio of a market capitalization corresponding to the first idea to a total market capitalization for the innovation market. The merit ranking also may consider user interest based on a total number of comments received for the first idea, as well as a number of page views that the first idea has generated. The reputation rank for each registered user may be based on a number of discussion posts received from that registered user; and a number of positive responses received from other users for that registered user's discussion posts.

In an alternate embodiment, a computer program product embodied in a computer-readable medium contains instructions that cause a processing device to perform a method. The method determines indications of merit for various ideas and may include receiving a first idea from a first registered user; displaying the first idea to additional registered users; receiving comments and rankings for the first idea from the additional registered users, and determining a merit ranking for the first idea. The merit ranking determination may consider at least a number of different registered users who have submitted comments for the first idea, a user interest for the first idea, and a reputation rank for registered users who have submitted a ranking for the first idea. The method also may include providing a reward to a second registered user based on the second registered user's submission of comments and rankings; and receiving, from the second registered user, an exchange of virtual currency for stock corresponding to the first idea.

Optionally, the determining a merit ranking includes assessing user interest based on a total number of comments received for the first idea and a number of page views that the first idea has generated. The determining a merit ranking also may include determining the reputation rank for each registered user based on a number of discussion posts received from that registered user and a number of positive responses received from other users for that registered user's discussion posts. The determining a merit ranking also may consider a ratio of a number of outstanding shares corresponding to the first idea to a total number of outstanding shares in the innovation market, and a ratio of a market capitalization corresponding to the first idea to a total market capitalization for the innovation market. Determining the reputation rank for each of the registered users who submitted the ranking also may be based on a number of positive rankings that have been received for ideas previously submitted by that registered user, and a number of negative rankings that have been received for ideas previously submitted by that registered user.

### BRIEF DESCRIPTION OF THE DRAWINGS

FIG. 1 illustrates an exemplary graphic user interface for an idea collaboration system.

FIG. 2 depicts an exemplary process of assessing the merit of various ideas.

FIG. 3 depicts an exemplary process of ranking the reputation of individual users of an idea collaboration system.

FIG. 4 is a block diagram of an exemplary system that may be used to contain or implement program instructions according to an embodiment

### DETAILED DESCRIPTION

Before the present methods and systems are described, it is to be understood that this disclosure is not limited to the particular methodologies and systems described, as these may vary. It is also to be understood that the terminology used in the description is for the purpose of describing the particular versions or embodiments only, and is not intended to limit the scope. For example, as used herein and in the appended claims, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

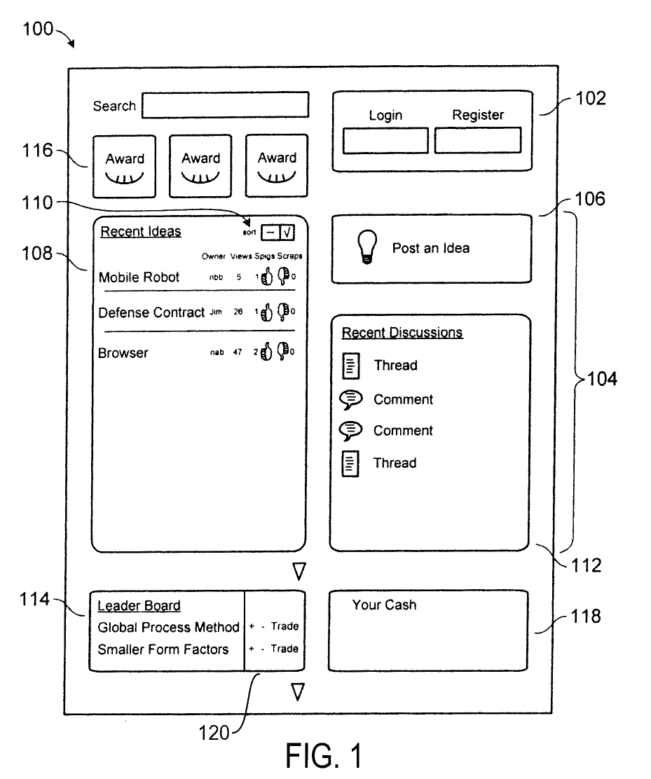

Referring to FIG. 1, elements of an idea collaboration system 100 are shown as accessed by a graphic user interface, such as a browser-based display that may be accessed via the Internet, an intranet or another communications network. The system 100 may be made accessible via networked computers, personal digital assistants, mobile electronic devices, and/or other electronic communication devices to individuals who are participants in an enterprise, such as a corporation, non-profit entity, university, research collaborative, trade organization, or other group. In some embodiments, access to some or all of the system may be limited to users who have registered with the system. This may help to limit access to employees, organization members, or other specified individuals. The system may include a user login interface 102, such as a username/password input field, a biometric input, or another electronic interface to limit access to users who have registered with, or granted access by, the system.

The system may include an Innovation Market 104, which is a portion 106 of an electronic user input interface that allow users to input ideas, and a display interface 108 that displays some or all the submitted ideas. Optionally, the hub 104 may include a display selector 110, which is an electronic user interface that allows a user to select how the ideas will be displayed, with options such as most recent, most popular, display by category, or display all.

The system may also include a Prediction Market 120, which is a portion of an electronic user input interface that offers shares (i.e., virtual ownership interests) in mutually exclusive set of outcomes, exactly one of which is determined to be true at a specified or yet-to-be-determined time in future. Users can use rewards, points, tokens or other virtual currency to purchase shares in one or more predicted outcomes. The share price is determined by any suitable method, such as the ratio of outstanding shares in the outcome to total number of outstanding shares and reputation level of users. When an outcome is determined to be true, all users who purchased shares of that outcome receive a virtual currency amount per share purchased that is equal to the maximum possible share price.

The Innovation Market 104 or another portion of the system also may include a discussion section 112, which is an electronic user interface that allows users to submit comments on and rankings for ideas, respond to other comments and rankings, and create discussion threads about ideas. The system also may include one or more an indication of merit sections 114, 116, each of which is a display that graphically or descriptively provides an indication of a merit ranking for submitted ideas. For example a merit section 116 may display “awardees”, or ideas which have achieved a highest ranking in one or more categories. Alternatively, a “leading ideas” section 114 may list any number of ideas having merit ranks that are higher than others, or merit ranks that exceed a user-selected or predetermined threshold. The display interface 108 also may include a merit indicator that allows a user to use the display selector 110 to selectively show the most popular ideas, most discussed ideas, a list of ideas having the highest number of user positive rankings, or another user-selected category. The system also may include a rewards section 118, which is a display that allows the user to see and use rewards, compensation or other items of value that the user has received from the system.

In an embodiment, the merit ranking of an idea may be indicated by a number that lies within a preset scale. In an embodiment, users can use their virtual currency in purchasing shares in any of the ideas presented to the system. The cost of a single share in the idea may be equal to, based on or otherwise related to the merit ranking of the idea at the time of purchase. Each idea has a finite life span and can have either a successful exit or an unsuccessful exit. Upon successful exit, each share purchased in the idea may pay back virtual currency equal to the maximum possible value of the merit index, or some other appropriate value.

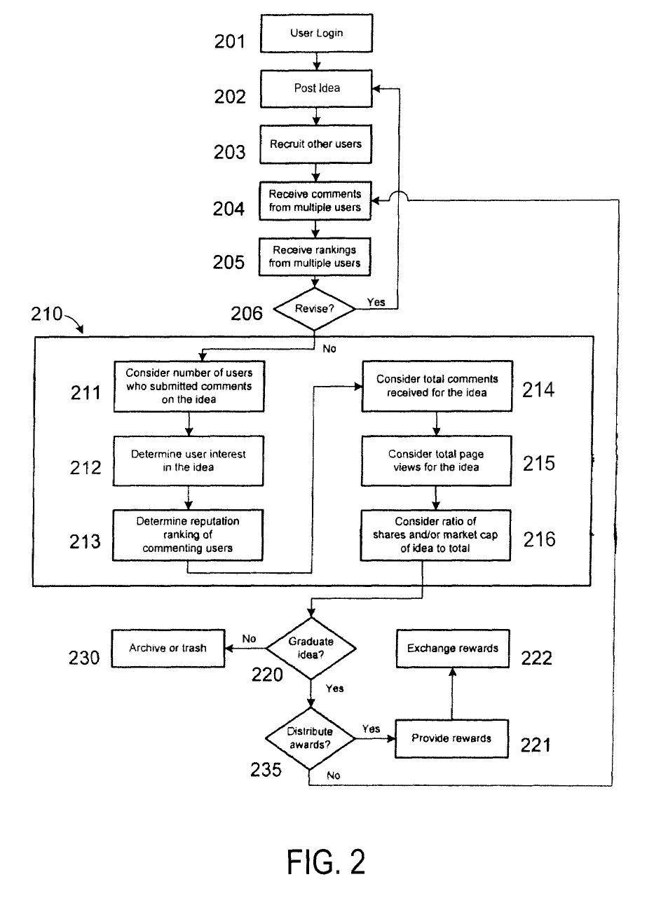

FIG. 2 illustrates an exemplary automated merit ranking process. A user may access 201 the system by logging in with a username and password, by a biometric entry (such as a fingerprint scan), or by some other means that authenticates the user to the system. In a captive computer network where the user has already been authenticated in order to access the network, a separate user login may or may not be needed for the user to access the idea collaboration system. The login also may allow a user to create and/or edit a stored user profile. The user profile may contain items such as a biography, work history, or other resume information; “connections” who are other users that agreed to be identified as connected to this user; links to the user's idea posts, comments, threads, reviews, blog entries or other information; rankings of the user or the user's ideas; recent activity, and rewards portfolio. Some or all of this information may be made available for other users to view. In some embodiments, the viewing of some or all of the information may be limited to individuals who are connected to this user.

In addition, during the registration process users may be required to accept a confidentiality agreement to ensure that ideas shared on the system are not disclosed outside of the enterprise for which the collaboration system is deployed.

A user may post an idea 202 by entering information describing the idea into the system. This may be done by filling out a fact sheet or other form with predetermined fields. At least one of the fields may permit the user to provide a free-form description of the idea. In addition, the user may be permitted to post one or more electronic files, such as articles, presentations, graphics, or videos, and associate the electronic files with the idea. The collaboration system receives an idea from the user and stores it in a computer-readable memory so that it can be displayed to other authorized users for review and comment. The idea may then be made available to other users on the system for review and comment.

Optionally the user who submitted the idea may recruit 203 other users to comment on the idea by identifying those other users so that the other users receive a message inviting them to view the idea.

Users may post comments 204 on the idea, such as reviews, questions, or suggestions for improving the idea. A comment may be positive or negative, so that the users also post a ranking 205 of the idea, such as “thumbs up/thumbs down”, a numeric ranking on a scale, a letter grade, or some other rank which indicates the user's impression of the idea. Other users may post responses to comments or rankings, thus creating a discussion thread about the idea. Optionally, users may be permitted to revise 206 a comment, ranking or idea after having the opportunity to see subsequent comments and rankings. In such a case, any or all of the previous steps may be repeated. Optionally, users may be limited in the number of rankings they can provide for an idea, although they may be permitted to purchase additional rankings by trading rewards, as described below.

The system determines a merit ranking 210 for the idea by considering factors such as any or all of the following: the total number of different users who submitted comments on the idea 211, user interest in the idea (such as by a measurement of the positive and/or negative comments or rankings received for the idea) 212, a reputation ranking of users who submitted comments and/or rankings 213, the total number of comments (optionally including discussion posts and rankings) for the idea 214, a total number of views (such as page views) of the idea 215, and a ratio 216 of outstanding shares and/or market capitalization of the idea to the total outstanding shares and/or total market capitalization of all ideas. Any of the factors listed above may be listed equally to or different from other factors. For example, in an embodiment greater weight may be given to negative comments than to positive comments, so that negative comments are more likely to affect the overall merit ranking than positive comments.

Based on the merit ranking, the user who submitted the idea may receive a reward 221, such as public recognition in a category, or an award that can be redeemed or exchanged 222 for other things in the system, including the ability to buy credits that allow the user to rank other ideas. Optionally, users may exchange 222 rewards between themselves, and an idea submitter may offer rewards to other users who help build popularity for the idea. Optionally, the determination of an award 222 may also be based on factors such as the user's individual reputation ranking. For example, the merit rank may be multiplied by the reputation rank to determine an award. The award determination also may be based on factors such as the number of ideas posted by a user, the number of comments that the user has posted for third party ideas, and other factors.

Optionally, before awards are distributed, an idea may be required to be filtered through one or more merit levels. After receiving comments and determining a ranking, and after a predetermined threshold (such as a time period or a number of received comments), the system may determine whether the idea should graduate to the next merit level 220. For example, if an idea receives less than a required number of positive comments during a time period, or if it receives more than a threshold number of negative comments during the time period, the idea may be archived or trashed 230 so that it is either removed from further public review or placed in a less prominent area of the system. If the idea does graduate to the next level, then the system determines whether to distribute rewards 235 and/or seek further public comment on the idea.

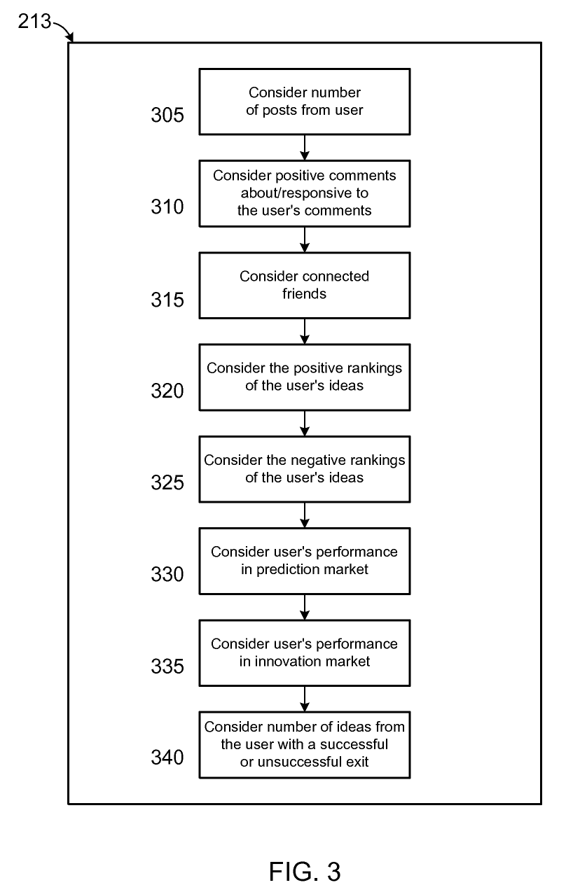

FIG. 3 provides additional detail about how a reputation ranking of a user may be determined (step 213 from FIG. 2). Referring to FIG. 3, a user's reputation ranking may be based on a mathematical calculation that considers factors such as any or all of the following: the number of posts (comments, rankings, ideas, etc.) that the user has submitted 305; the number of positive (or negative) comments 310 that have been received about or in response to the user's comments; the number of other users who have agreed to be connected to this user 315; the number of positive rankings that the user has received for his or her own ideas, comments, reviews, blog posts and discussion threads 320; the number of negative rankings that the user has received for his or her own ideas, comments, reviews, blog posts and discussion threads 325; a measure of the user's past performance in correctly betting on Prediction Market instruments 330; a measure of the user's past performance in investing and rating in ideas in the Innovation Market that exit successfully 335; or the number of ideas posted by the user that have a successful or unsuccessful exit 340.

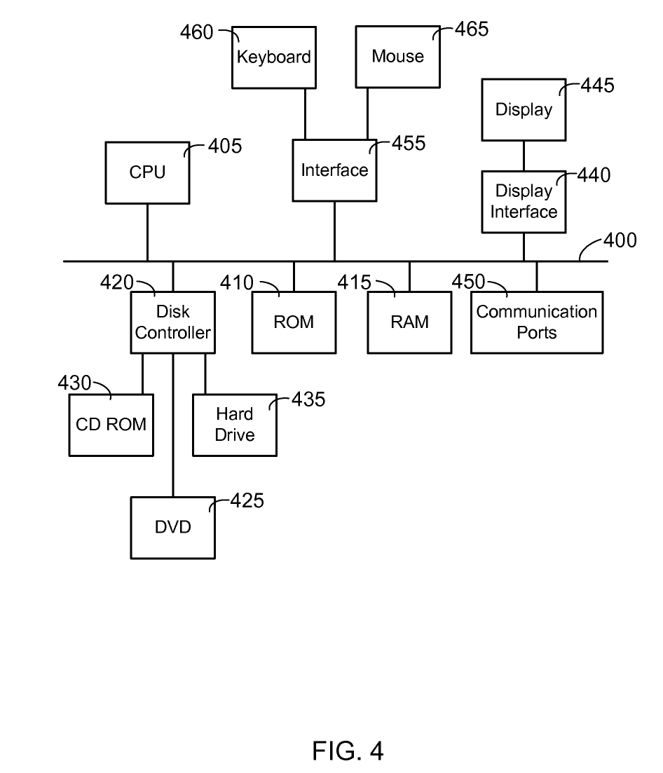

Any or all of the methods described herein may be embodied in computer-readable code that instructs processing device to implement the methods. FIG. 4 depicts a block diagram of an exemplary system that may be used to contain or implement program instructions according to an embodiment. Referring to FIG. 4, a bus 400 serves as the main information highway interconnecting the other illustrated components of the hardware. CPU 405 is the central processing device of the system, performing calculations and logic operations required to execute a program. Read only memory (ROM) 410 and random access memory (RAM) 415 constitute exemplary memory devices or storage media that may hold the computer-readable code.

A disk controller 420 interfaces with one or more optional disk drives to the system bus 400. These disk drives may include, for example, external or internal disk, flash memory, USB or other drives 425, CD ROM drives 430 or hard drives 435. As indicated previously, these various disk drives and disk controllers are optional devices.

Program instructions may be stored in the ROM 410 and/or the RAM 415. Optionally, program instructions may be stored on a computer readable storage medium, such as a hard drive, a compact disk, a digital disk, a memory or any other tangible recording medium.

An optional display interface 440 may permit information from the bus 400 to be displayed on the display 445 in audio, graphic or alphanumeric format. Communication with external devices may occur using various communication ports 450.

In addition to the standard computer-type components, the hardware may also include a data input interface 455 which allows for receipt of data from input devices such as a keyboard 460 or other input device 465 such as a mouse, remote control, touch pad or screen, pointer and/or joystick

It will be appreciated that various of the above-disclosed and other features and functions, or alternatives thereof may be desirably combined into many other different systems or applications. Various presently unforeseen or unanticipated alternatives, modifications, variations or improvements therein may be subsequently made by those skilled in the art which are also intended to be encompassed by the following claims.

What is claimed is:

1. An idea collaboration system, comprising:
an innovation market that accepts and displays a plurality of user-submitted ideas;
a discussion section that for a first one of the user-submitted ideas, accepts from registered users comments and rankings about the first idea;
an idea merit section that determines, using a processing device, and displays, via a display device, an indication of merit for the first idea, where the indication of merit is a measurement based on at least:
a number of different registered users who have submitted comments to the discussion section for the first idea,
a determination of user interest for the first idea, and
a reputation rank for each registered user from whom the discussion section received a positive ranking for the first idea.

2. The system of claim 1, wherein the indication of merit is also based on:
a ratio of a number of outstanding shares corresponding to the first idea to a total number of outstanding shares in the innovation market; and
a ratio of a market capitalization corresponding to the first idea to a total market capitalization for the innovation market.

3. The system of claim 1, wherein the determination of user interest in the first idea is based on at least:
a total number of comments that have been received into the discussion section for the first idea; and
a number of page views that the first idea has generated.

4. The system of claim 1, wherein the reputation rank for each registered user is determined based on:
a number of discussion posts that the discussion section has received from the registered user; and
a number of positive responses to the registered user's discussion posts that the discussion section has received from other users.

5. The system of claim 4, wherein the reputation rank for each registered user is also based on:
a past performance of the registered user in correctly betting on prediction market instruments; and
a past performance of the registered user in correctly rating and buying shares in ideas in the innovation market.

6. The system of claim 5, wherein the reputation rank for each registered user is also based on a past performance of the registered user in posting ideas with successful exit.

7. The system of claim 6, wherein the reputation rank for each registered user is also determined based on:
a number of friends that have connected to the registered user as connected friends;
a number of positive rankings that the connected friends have submitted for the registered user; and
a number of negative rankings that the connected friends have submitted for the registered user.

8. The system of claim 1, further comprising a reward module that provides rewards to registered users based on their participation in the discussion section, their reputation level, and the merit ranking of their ideas.

9. The system of claim 8, wherein:
the idea merit section also determines whether the first idea should graduate to a next level; and
the reward module also provides a reward to a submitter of the first idea if the idea merit system determines that the idea should graduate to the next level.

10. A method of collaboration, comprising:
receiving, into an idea collaborative system, a first idea from a first registered user;
displaying the first idea to a plurality of additional registered users;
receiving from the plurality of registered users into the idea collaboration system, a plurality of comments and a plurality of rankings for the first idea;
determining, by a processing device, a merit ranking for the first idea, where the determining considers at least:
a number of different registered users who have submitted comments for the first idea;
a user interest for the first idea, and
a reputation rank for registered users who have submitted a ranking for the first idea.

11. The method of claim 10, wherein the determining also considers:
a ratio of a number of outstanding shares corresponding to the first idea to a total number of outstanding shares in the innovation market; and
a ratio of a market capitalization corresponding to the first idea to a total market capitalization for the innovation market.

12. The method of claim 10, wherein the determining further comprises calculating the user interest based on:
a total number of comments received for the first idea, and
a number of page views that the first idea has generated.

13. The method of claim 10, wherein the determining further comprises calculating the reputation rank for each registered user based on:
a number of discussion posts received from that registered user; and
a number of positive responses received from other users for that registered user's discussion posts.

14. The method of claim 14, wherein calculating the reputation rank for each of the registered users who submitted the ranking is also based on:
a number of positive rankings that have been received for ideas previously submitted by that registered user; and
a number of negative rankings that have been received for ideas previously submitted by that registered user.

15. The system of claim 14, wherein calculating the reputation rank is also based on:
a number of friends that have connected to that registered user as connected friends;
a number of positive rankings that the connected friends have submitted for that registered user; and
a number of negative rankings that the connected friends have submitted for that registered user.

16. The method of claim 10, further comprising:
providing a reward to a second registered user based on the second registered user's submission of comments and rankings; and receiving, from the second registered user, an exchange of virtual currency or the rewards for stock corresponding to the first idea.

17. The method of claim 10, further comprising determining whether the first idea should graduate to a higher merit level, and if not, then moving the first idea to an archive or removing the first idea from a discussion section of the idea collaboration system.

18. A computer-program product containing computer-readable code that instructs a computing device to perform a method of determining indications of merit for a plurality of ideas, the method comprising:
receiving a first idea from a first registered user;
displaying, via a display device, the first idea to a plurality of additional registered users;
receiving from the additional registered users a plurality of comments and a plurality of rankings for the first idea;
determining, by a processor of the computing device, a merit ranking for the first idea, where the determining considers at least:
a number of different registered users who have submitted comments for the first idea;
a user interest for the first idea, and
a reputation rank for registered users who have submitted a ranking for the first idea,
providing, via the processing device, a reward to a second registered user based on the second registered user's submission of comments and rankings; and
receiving, from the second registered user, an exchange of virtual currency for stock corresponding to the first idea.

19. The computer-program product of claim 18, wherein the determining further comprises:
assessing the user interest based on a total number of comments received for the first idea and a number of page views that the first idea has generated; and
calculating the reputation rank for each registered user based on a number of discussion posts received from that registered user and a number of positive responses received from other users for that registered user's discussion posts.

20. The computer-program product of claim 19 wherein:
the determining also considers:
a ratio of a number of outstanding shares corresponding to the first idea to a total number of outstanding shares in the innovation market, and
a ratio of a market capitalization corresponding to the first idea to a total market capitalization for the innovation market; and
calculating the reputation rank for each of the registered users who submitted the ranking is also based on:
a number of positive rankings that have been received for ideas previously submitted by that registered user, and
a number of negative rankings that have been received for ideas previously submitted by that registered user.
